(19) United States
(12) Patent Application Publication
(10) Pub. No.: US 2017/0209989 A1
(43) Pub. Date: Jul. 27, 2017

(54) MULTIFUNCTIONAL SCREWDRIVER

(71) Applicant: Shanghai Easy-Use Tools Enterprise Co. Ltd., Shanghai (CN)

(72) Inventor: Shiyu SUN, Shanghai (CN)

(21) Appl. No.: 15/258,870

(22) Filed: Sep. 7, 2016

(30) Foreign Application Priority Data
Jul. 8, 2015 (CN) 201520490190.X

(51) Int. Cl. B25B 15/04; B25B 23/00

(52) U.S. Cl. CPC B25B 15/04; B25B 23/0007

(57) ABSTRACT

This disclosure discloses a multifunctional screwdriver, in which the ratchet head is provided with flanged structures, grooves and gap structures, the gap structure is provided with circular holes inside, and the bottom of the ratchet head is provided with a projecture. The matching shaft is provided with embossments and a connecting hole. The front end surface of the handle is provided with a mounting hole matched with the matching shaft, and the back end surface of the handle is provided with a shape-matching hole. One end of the matching shaft which has said embossment is connectable to said ratchet head, the embossment is inserted in said circular hole, and the projecture is connectable to the shape-matching hole. Through the assembly of the projecture and the shape-matching hole, it allows the user to use the screwdriver in narrow working environment.

### CROSS-REFERENCE TO RELATED APPLICATIONS

The present application claims priority to and the benefit of Chinese Patent Application No. CN 201520490190.X, filed on Jul. 8, 2015, the entire content of which is incorporated herein by reference.

### BACKGROUND OF THE INVENTION

1. Field of the Invention

The present patent application relates to the field of daily hardware, more specifically, to multifunctional screwdriver.

2. Description of the Related Art

The existing screwdriver provides a lot of conveniences to people's life, which is mainly used to fasten or loosen the screws. The structure of the most common screwdriver in prior art generally includes a screwdriver handle, a screwdriver rod and a screwdriver head, and the screwdriver, screwdriver rod and screwdriver head are fixed as an one-piece structure. When using the screwdriver, the user has to constantly loose or clench the palm of his/her hands, which allows the palm to be located at a position easy to apply force. When the user are loosing or clench the palm, the screwdriver head is easily separated from the screw, so it is very inconvenient to operate the screwdriver.

### SUMMARY OF THE PATENT APPLICATION

In view of this, the present patent application provides a multifunctional screwdriver, in order to solve the problem that the conventional screwdrivers are not convenient for use in prior art.

In order to achieve the objectives mentioned above, the technical proposals of the present patent application are realized as follows:

A multifunctional screwdriver, comprising:

a ratchet head, in which a matching hole is provided, the matching hole being configure with two circular holes opposite to each other at interior of center of the ratchet head, and the ratchet heat being provided with an projecture at its bottom;

a matching shaft, an embossment being provided at two sides of one end of the matching shaft, and a connecting hole being provided at the other end of the matching shaft;

a handle, front end surface of the handle is provided with a mounting hole matched with said matching shaft, and back end surface of the handle is provided with a shape-matching hole;

wherein, one end of the matching shaft which has said embossment is connectable to the ratchet head, the embossment is inserted in the circular hole, and the projecture is connectable to the shape-matching hole.

Preferably, the multifunctional screwdriver as disclosed above, wherein said handle has a columnar structure in direction of length, and one end of the handle is concave and curved inwards.

Preferably, the multifunctional screwdriver as disclosed above, wherein said matching hole is matched with said matching shaft in diameter size.

Preferably, the multifunctional screwdriver as disclosed above, wherein id shape-matching hole is matched with said projecture in size.

Preferably, the multifunctional screwdriver as disclosed above, wherein a plurality of flange structures are provided at periphery of the ratchet head, a plurality of grooves are formed between each two of the flange structures which are adjacent to each other, and the matching hole is located in one of said grooves.

Since the present patent application adopts the mentioned-above technical proposals, positive effects can be achieved as follows:

In the present patent application, the ratchet head and the handle of the screwdriver can be connected by various coordination modes, one end of the connecting hole is connected with the handle, and one end of the projecture is connected with the ratchet head, and the matching shaft can rotate relative to the ratchet head by 90 degree, namely it can fasten the screwdriver in the vertical direction, and also can increase the torque of the screwdriver, reduce the power output from users, and thus save physical capacity; through the installation of the projecture and the matching hole, it allows the user to use the screwdriver in narrow working environment, for example, to hold the handle and rotate the handle, which is easy to operate. The ratchet head can be matched with the handle and then used as a ratchet wrench, and can also be singly used as a palm ratchet wrench; the ratchet head can be matched with the handle and then used as a screwdriver.

### BRIEF DESCRIPTIONS OF THE DRAWINGS

Accompanying drawings constituting part of the present patent application is provided for further comprehension of the present patent application, the present patent application of exemplary embodiments and illustration thereof are provided to explain the present patent application, which does not limit the scope of the present patent application. In the accompanying drawings:

FIG. 1 shows an assembly diagram of the ratchet head and the handle of the multifunctional screwdriver of the present patent application;

FIG. 2 shows another assembly diagram of the ratchet head and the handle of the multifunctional screwdrivers of the present patent application;

FIG. 3 shows a structure diagram of the ratchet head of the multifunctional screwdriver of the present patent application;

FIG. 4 shows a structure diagram of the matching shaft of the multifunctional screwdriver of the present patent application;

FIG. 5 shows an assembly diagram of the ratchet head and the matching shaft of the multifunctional screwdrivers of the present patent application;

FIG. 6 shows a structure diagram of another ratchet head of the multifunctional screwdriver of the present patent application.

### DESCRIPTIONS OF THE PREFERRED EMBODIMENTS

Hereinafter, certain embodiments according to the present patent application will be described with reference to the accompanying drawings below, but do not limit the scope of the present patent application.

### Embodiments

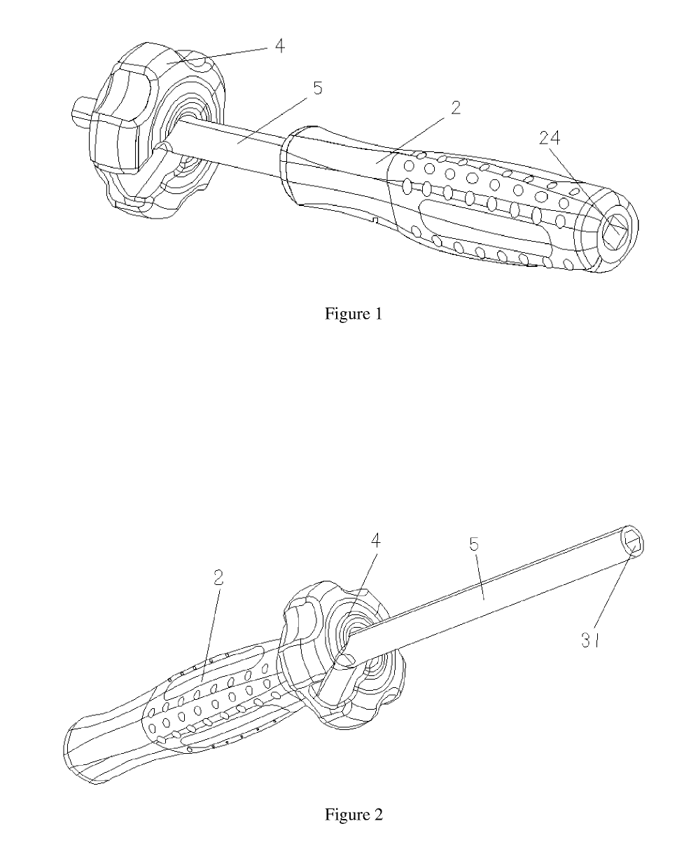

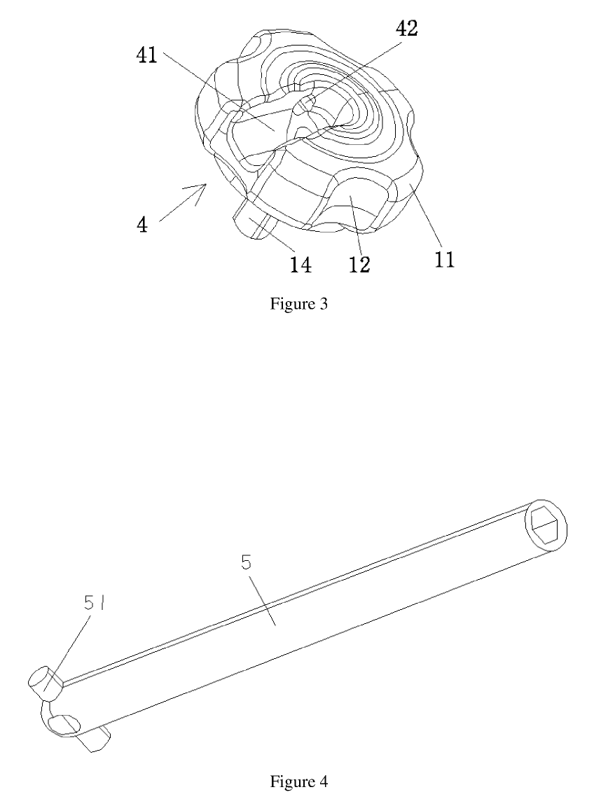

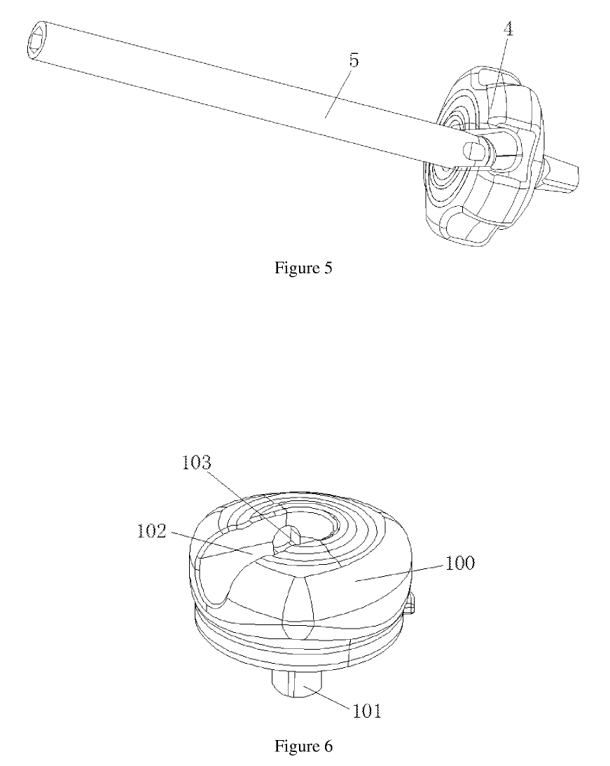

Please refer to FIGS. 1 to 5, the multifunctional screwdriver of the present patent application is characterized in that it comprises:

A ratchet head 4, a plurality of flange structures 11 being provided at periphery of the ratchet head 4, a plurality of grooves 12 being formed between each two of the flange structures 11 which are adjacent to each other, and one of said grooves 12 being provided with a gap structure 41 inside, the gap structure 41 being provided with two circular holes 42 which is inside the gap structure 41 and opposite to each other being located at center of the ratchet head 4, and the ratchet heat 4 being provided with an projecture 14 at its bottom;

A matching shaft 5, two sides at one end of the matching shaft 5 being provided with an embossment 51, and the other end of the matching shaft 4 being provided with a connecting hole 31;

A handle 2, the front end surface of the handle 2 is provided with a mounting hole (not shown) matchable with the structure of the matching shaft 5, and the back end surface of the handle 2 is provided with a shape-matching hole 24;

wherein, one end of the matching shaft 5 which has said embossment 51 is connectable to the ratchet head 4, the embossment 51 is inserted in the circular hole 42, and the projecture 14 is connectable to the shape-matching hole 24 in the handle 2.

On the basis of the above, the present patent application also provides the following embodiments, please continue referring to FIGS. 1 to 5,

In a further embodiment of the present patent application, the handle 2 has a columnar structure in the direction of the length, and one end of the handle is concave and curved inwards.

In a further embodiment of the present patent application, the diameter of the gap structure 41 is matched with the diameter of the matching shaft 5.

In a further embodiment of the present patent application, the size of the shape-matching hole 24 structure is matched with the size of the projecture 14.

Users can further understand the characteristics and functions of the present patent application according to the following illustrations,

In this embodiment, ratchet head 4 is provided with a gap structure 41, two circular holes 42 are provided at the center of the ratchet head 4, a connecting hole 31 is provided at the end surface of the matching shaft 5, an embossment 51 is provided at two sides of the other end, one end of the matching shaft 5 which has said embossment 51 is connectable to the ratchet head 4 (as shown in FIG. 1), the size of the gap structure 41 is matched with the diameter of the matching shaft 5, which allows the matching shaft 5 to be rotated at a 90 degree. when the matching shaft, the ratchet head and the handle are assembled as FIG. 1 shows, the user can fasten screws in the vertical direction, the configuration as shown in FIG. 1 can increase the torque of the screwdriver, and also can reduce the power output of users, and thus save users' physical capacity; when the matching shaft, the ratchet head, and the handle are assembled as FIG. 2 shows, projecture can be inserted in the shape-matching hole 24 of the handle 2, which allows to use the screwdriver under a working condition of narrow space, and thus the work efficiency is improved.

Therefore, the ratchet head can be matched with the handle to use as a ratchet wrench or a screwdriver, and alternatively, the ratchet head also can be used singly as a palm ratchet wrench.

Moreover, this embodiment also provides a ratchet head 100 with another structure, the ratchet head 100 has a triangular structure, the bottom of the ratchet head is provided with a projecture 101, the ratchet head is provided with a matching hole 102 inside, two circular holes 103 which are opposite to each other are provided inside the matching hole 102, the matching hole 102, the circular hole 103 and the matching shaft 5 are matched with each other and assembled, which has the same technical effect as the assembly of ratchet head 100, handle 2 and matching shaft 5 mentioned above, as the certain implementation method is the same as that of the structure mentioned above, so it will not be described here.

The above mentioned is merely the better embodiment of the patent application, the implementation method and the protection scope of the patent application are not limited by that, for artisan in this field, it is to be understood that the equivalent replacement and the obvious change of the specification and the illustrations of the present patent application shall be included in the protection scope of the present patent application.

What is claimed is:

1. A multifunctional screwdriver, comprising:
a ratchet head, in which a matching hole is provided, the matching hole being configure with two circular holes opposite to each other at interior of center of the ratchet head, and the ratchet heat being provided with an projecture at its bottom;
a matching shaft, an embossment being provided at two sides of one end of the matching shaft, and a connecting hole is provided at the other end of the matching shaft;
a handle, front end surface of the handle is provided with a mounting hole matched with said matching shaft, and back end surface of the handle is provided with a shape-matching hole;
wherein, one end of the matching shaft which has said embossment is connectable to said ratchet head, the embossment is inserted in said circular hole, and the projecture is connectable to the shape-matching hole.

2. The multifunctional screwdriver as disclosed in claim 1, wherein said handle has a columnar structure in direction of length, and one end of the handle is concave and curved inwards.

3. The multifunctional screwdriver as disclosed in claim 1, wherein said matching hole is matched with said matching shaft in diameter size.

4. The multifunctional screwdriver as disclosed in claim 1, wherein the shape-matching hole is matched with said projecture in size.

5. The multifunctional screwdriver as disclosed in claim 1, wherein a plurality of flange structures are provided at periphery of the ratchet head, a plurality of grooves are formed between each two of the flange structures which are adjacent to each other, and the matching hole is located in one of said grooves.
